(19) United States
(12) Patent Application Publication
(10) Pub. No.: US 2004/0183655 A1
(43) Pub. Date: Sep. 23, 2004

(54) Passive keyless entry system for vehicle

(75) Inventor: Tomosuke Takata, Miyagi-ken (JP)

Correspondence Address: Brinks Hofer Gilson & Lione, P. O. Box 10395, Chicago, IL, 60610, US

(73) Assignee: Alps Electric Co., Ltd.

(21) Appl. No.: 10/796,821

(22) Filed: Mar. 9, 2004

(30) Foreign Application Priority Data
Mar. 13, 2003 (JP) 2003-068524

(51) Int. Cl. B60R 25/00; H04Q 1/00

(52) U.S. Cl. 340/5.72

(57) ABSTRACT

A passive keyless entry system for unlocking and locking a door-locking mechanism by the operations of pulling and pushing the outside handle of a vehicle is provided. The passive keyless entry system for locking and unlocking the vehicle door comprises trigger switches. The switches are attached to the outside handle 1 for opening or closing the vehicle door. The trigger switches consist of a first switch 5 turned on or off in the position A where the operation of pulling the outside handle 1 from the normal position O is performed and a second switch 7 turned on or off in the position B where the operation of pushing the outside handle 1 from the normal position O is performed. The vehicle door is unlocked by the first switch 5 and is locked by the second switch 7.

### BACKGROUND OF THE INVENTION

1. Field of the Invention

The present invention relates to a technology of a passive keyless entry system, which is a method of automatically locking and unlocking a vehicle door by communication with a portable unit.

2. Description of the Related Art

Conventional keyless entry systems for locking or unlocking door-locking mechanisms of a vehicle include passive and manual keyless entry systems. Passive keyless entry systems perform bi-directional communication between remotely held portable units and vehicle-mounted units, whereas manual keyless entry systems perform unidirectional communication between the remotely held portable units and the vehicle-mounted units. In order to automatically lock or unlock a door of an automotive vehicle such as a passenger automobile, a passive keyless entry system performs bi-directional communication between a remotely held portable unit carried by a person and a vehicle-mounted unit mounted on a vehicle. The passive keyless entry system thereby locks or unlocks a door-locking mechanism when the vehicle-mounted unit determines that the remotely held portable unit is an authentic portable unit as a result of an authenticating process confirming the authenticity of a portable unit ID and a vehicle ID.

An example of a specific function of the passive keyless entry system will now be described. A vehicle-mounted unit 2 transmits a request signal that is broadcast at a recurring interval over time and is uniform in its frequency of occurrence. The request signal includes a vehicle-mounted unit ID and whose broadcast range extends a relatively short distance. When a portable unit 20 is outside the effective broadcast range of the request signal transmitted by the vehicle-mounted unit, the portable unit does not receive the request signal. When a person who carries the remotely held portable unit approaches a vehicle and enters the effective range of the request signal broadcasted by the vehicle-mounted unit, the remotely held portable unit will check the vehicle-mounted unit ID that the onboard unit had embedded within its request signal. When the portable unit determines that the vehicle-mounted unit ID has been transmitted from an authentic vehicle-mounted unit, the portable unit transmits a response signal in reply to the vehicle-mounted unit's request signal.

The vehicle-mounted unit receives the response signal, derives the portable unit ID included in the response signal, collates the portable unit ID registered in a memory and the portable unit ID in the response signal. The vehicle-mounted unit transmits an unlock signal to. the door-locking mechanism when the portable unit ID and the registered portable unit ID match. The door-locking mechanism then is unlocked (the locking of the door-locking mechanism is released). When the person who carries the portable unit gets off the vehicle and goes away therefrom, the vehicle-mounted unit transmits a lock signal to the door-locking mechanism at the moment in time when the portable unit cannot receive the request signal, that is, at the moment in time when the vehicle-mounted unit cannot receive the response signal.

According to structural examples other than the passive keyless entry system, when an operator gets on a vehicle, the door-locking mechanism is unlocked by communications between the vehicle-mounted unit and the portable unit using the operation of an outside handle in the vehicle's door as a trigger. When the operator gets off the vehicle, the door-locking mechanism is locked by sensing the operation of the outside handle on the condition where the state of the vehicle door is changed from openness to closeness (For example, refer to Patent Document 1). Since there is no description that a method of operating the outside handle when the operator gets on a vehicle is not distinguished from a method of operating the outside handle when the operator gets off the vehicle, the operation of the outside handle when the operator getting on a vehicle is not dissimilar from the operation of the outside handle when the operator gets off the vehicle.

[Patent Document 1]

Japanese Unexamined Patent Application Publication No.

According to the above-mentioned general related art, since the vehicle-mounted unit must always transmit the request signal even when the portable unit is remote from the vehicle, economy in power consumption of the vehicle matters.

In the passive keyless entry system of Patent Document 1, the communication between the vehicle-mounted unit and the portable unit are triggered by the operation of the outside handle. Thus, the matter of the economy in power consumption of the vehicle is solved. However, the way for instructing the locking mechanism to be unlocked when the operator gets on a vehicle is the same as that for instructing the locking mechanism to be locked when the operator gets off the vehicle. In other words, the operation of pulling the outside handle triggers a passive operation in any case. Therefore, means for distinguishing the unlocking of the vehicle door when the operator gets on a vehicle from the locking of the vehicle door when the operator gets off the vehicle is required. In Patent Document 1, the history of the openness and the closeness of the vehicle door are used as the above means particularly with respect to the locking of the vehicle door when the operator gets off the vehicle. It is determined whether the locking of the vehicle door is intended when the operator gets off the vehicle by sensing that the outside handle is pulled after the vehicle door is opened and then that the vehicle door is closed.

However, the operation of an operator required for adopting the means is extremely unnatural. In other words, after opening the vehicle door in order to get off the vehicle and getting out of the vehicle, the operator must look for the outside handle of the vehicle door, which is opened and is not positioned, and then close the vehicle door after pushing the outside handle to the original position. Further, there exists a function of locking the door-locking mechanism by closing the vehicle door with the outside handle of the opened door pulled as mentioned above in addition to the function of the passive keyless entry system. However, the above-mentioned operation is troublesome and the function itself does need not accompany the passive keyless entry system.

When the outside handle is pulled, the vehicle door is opened after releasing the locking of the door-locking mechanism by pulling the outside handle when the operator gets on a vehicle and the door-locking mechanism is locked by pulling the outside handle when the operator gets off the vehicle. However, it is not natural to lock the door-locking mechanism by performing the same operation as the operation for releasing the locking of (unlocking) the door-locking mechanism from the viewpoint of the operation (since the door-locking mechanism is locked by performing the operation of pulling the outside handle). This is also important in terms of crime prevention. That is, when the operator operates the outside handle in order to get in the vehicle, the locking of the door-locking mechanism is released. However, if the operator changes his or her mind and goes away from the vehicle without opening the vehicle door at the moment in time when the locking of the door-locking mechanism is released, a state in which the locking of the door-locking mechanism is released is maintained. As a result, the matter of the crime prevention is caused. That is, there is a high probability that the operator considers that the door-locking mechanism is locked irrespective of the operation for locking or unlocking the door-locking mechanism.

### SUMMARY OF THE INVENTION

It is an object of the present invention to provide a method of operating an outside handle and an apparatus therefor in which the operation of the outside handle is used to trigger the locking and unlocking of a door-locking mechanism and in which the operations of locking and unlocking the door-locking mechanism are certainly and intentionally performed.

In order to achieve the above object, the present invention adopts the following structures. A passive keyless entry system for locking or unlocking a vehicle door comprises trigger switches for transmitting a request signal to a portable unit. The trigger switches are attached to an outside handle for opening or closing the vehicle door, the trigger switches. The trigger switches comprise a first switch turned on or off by the operation of pulling the outside handle from a normal position and a second switch turned on or off by the operation of pushing the outside handle from the normal position. A request signal is transmitted from the vehicle to the portable unit by the first switch operation and, when the request signal includes an authentic portable unit ID, the portable unit transfers a response signal to thereby unlock the vehicle door. A request signal is transmitted from the vehicle to the portable unit by the second switch operation and, when the request signal includes an authentic portable unit ID, the portable unit transfers a response signal to thereby lock the vehicle door.

It is possible to certainly and intentionally perform the operations of locking and unlocking the door-locking mechanism with simple structures by adopting the above-mentioned structures.

### BRIEF DESCRIPTION OF THE DRAWINGS

FIG. 1 is a block diagram illustrating aspects of operating and switching an outside handle in a passive keyless entry system according to an embodiment of the present invention;

FIG. 2 illustrates an aspect of the operation of the passive keyless entry system according to the present embodiment for unlocking a door-locking mechanism; and

FIG. 3 illustrates an aspect of the operation of the passive keyless entry system according to the present embodiment for locking the door-locking mechanism.

### DESCRIPTION OF THE PREFERRED EMBODIMENTS

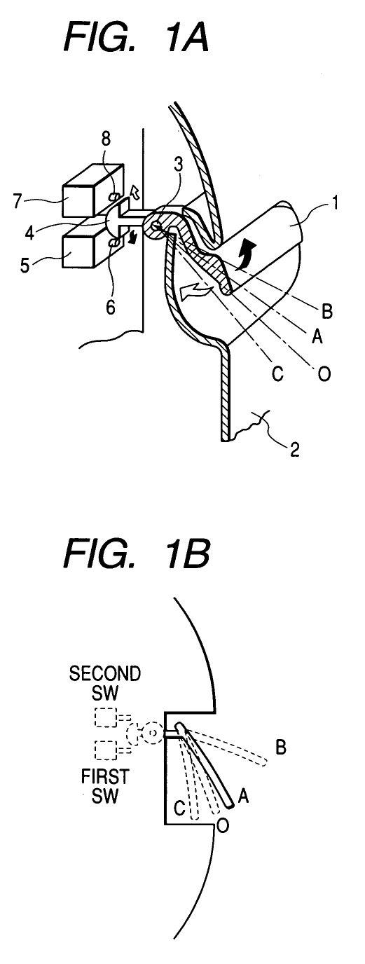

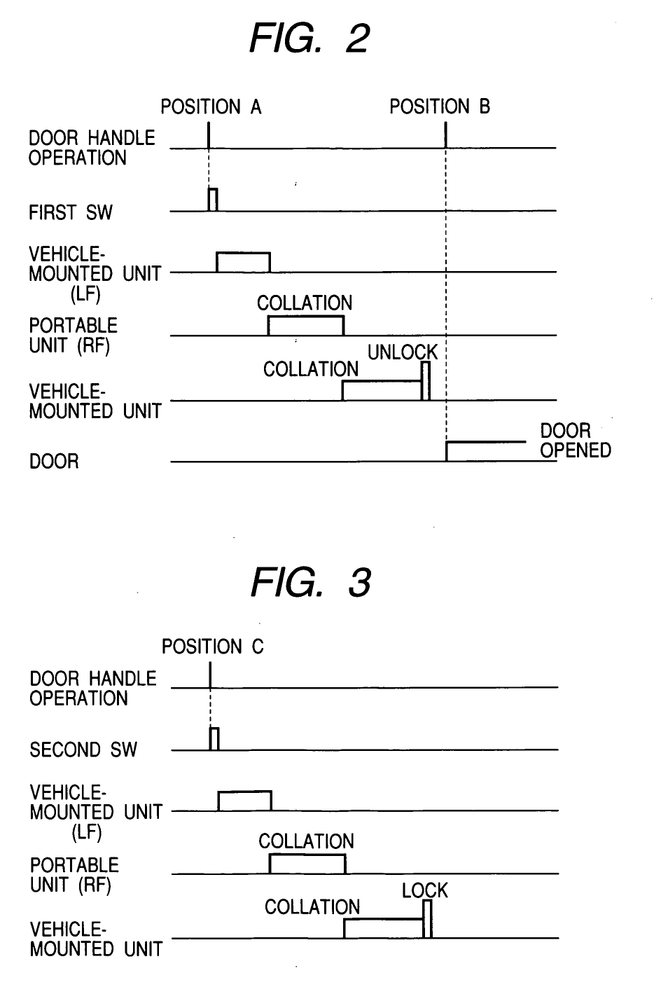

A passive keyless entry system and a method of operating the same according to an embodiment of the present invention will now be described with reference to FIGS. 1, 2, and 3. FIG. 1 is a block diagram illustrating aspects of operating and switching an outside handle in the passive keyless entry system according to the embodiment of the present invention. FIG. 2 illustrates an aspect of the operation of the passive keyless entry system according to the present embodiment for unlocking a door-locking mechanism. FIG. 3 illustrates an aspect of the operation of the passive keyless entry system according to the present embodiment for locking the door-locking mechanism.

Here, reference numerals 1, 2, 3, 4, 5, 6, 7, and 8 denote an outside handle, a door outer plate, a rotary shaft, a driving unit, a first switch, a first actuator, a second switch, and a second actuator, respectively.

FIG. 1 illustrates the periphery of the outside handle of a vehicle door. FIG. 1A is a schematic view illustrating relations between the operation positions of the outside handle and the first and second switches. FIG. 1B is a sectional view illustrating the operation position of the outside handle. In FIG. 1, a recess into which a hand is put is provided in the external surface of the door outer plate 2 so that the outside handle 1 can be pulled or pushed using the rotary shaft 3 provided in the upper portion of the recess as a pivotal point. A circuit substrate having an electric circuit mounted thereon is received inside the vehicle door. Two switches, that is, the first switch 5 and the second switch 7 are mounted on the circuit substrate that faces a portion in which the outside handle 1 is mounted. The first actuator 6 and the second actuator 8 protrude from the cases of the first and second switches 5 and 7 on the side of the outside handle. The driving unit 4 extending to the central positions of the two switches 5 and 7 is integrally attached to the outside handle 1 in the directions of the first switch 5 and the second switch 7. In the shape of the driving unit 4, the side that faces the two switches 5 and 7 is formed substantially in an arc shape. The driving unit 4 is separated from the two switches 5 and 7 when the outside handle 1 is not operated. When the outside handle 1 is operated, the arc-shaped surface is moved to press the first actuator 6 of the first-switch 5 to turn on the first switch 5 or to press the second actuator 8 of the second switch 7 to turn on the second switch 7.

In the embodiment of the present invention, it is assumed that the position O of the outside handle 1 is the normal position of the outside handle 1 when the vehicle door is closed, and when a operator pivots the outside handle 1 using the rotary shaft 3 as a pivotal center while getting on a vehicle, the vehicle door is forcibly opened based on the operation force of the vehicle door in the position B.

First, the basic function of the present embodiment will be schematically described. A door-locking mechanism is unlocked by bi-directional communication between a vehicle-mounted unit and a portable unit with the lapse of the operations of the outside handle 1 from the position O to the position B when the operator gets on a vehicle. Further, the door-locking mechanism is locked by the bi-directional communication between the vehicle-mounted unit and the portable unit by further pushing the outside handle 1 inwardly from the position O when the operator gets off the vehicle.

Specifically, the outside handle 1 holds its stable position in the normal position O with biasing means (not shown). When the outside handle 1 is pulled to the direction of the position B, the second actuator 8 of the first switch 5 is operated in the position A where the outside handle 1 is positioned in an initial stage of the pulling operation, by the driving unit 4 integral with the outside handle 1 to thereby turn on the first switch 5. To the contrary, when the outside handle 1 is pushed from the normal position O to the position C, the second actuator 8 of the second switch 7 is operated by the driving unit 4 integral with the outside handle 1 to thereby turn on the second switch 7.

In FIG. 2, according to the passive keyless entry (P-RKE) system of the present embodiment, when the operator pulls the outside handle 1 in the direction from the normal position O to the position B while getting on the vehicle (refer to FIG. 1), the first actuator 6 of the first switch 5 is operated in the position A where the pulling operation is initially performed to thereby generate a trigger signal that allows the vehicle-mounted unit to transmit a low frequency (LF) request signal including an vehicle-mounted unit ID. The portable unit receives the request signal and collates the vehicle-mounted unit ID included in the received request signal with an authentic vehicle-mounted unit ID. When the two vehicle-mounted unit IDs coincide with each other, after determining whether the trigger signal has been received from the first switch 5, the door-locking mechanism is unlocked (the locking of the door-locking mechanism is released.). Next, it is possible to forcibly open the door outer plate 2 of the unlocked door by the operator pivoting the outside handle 1 to the position B.

In FIG. 3, when the operator pushes the outside handle 1 to the direction of the position C that is opposite to the direction of the position B, in which the vehicle door is opened, using the PKE system according to the present embodiment, while getting off the vehicle (refer to FIG. 1), the second actuator 8 of the second switch 7 is operated in the position C where the pushing operation is performed to thereby generate the trigger signal that allows the vehicle-mounted unit to transmit the LF request signal including the vehicle-mounted unit ID. The portable unit receives the request signal, collates the vehicle-mounted unit ID included in the received request signal with an authentic vehicle-mounted unit ID, and transmits a radio frequency (RF) response signal including a portable unit ID. The vehicle-mounted unit receives the response signal, collates the portable unit ID included in the received response signal with an authentic portable unit ID, and locks the door-locking mechanism after determining that the trigger signal has been received from the second switch 7 when the former coincides with the latter. Moreover, the door-locking mechanism is locked after forcibly closing the door outer plate 2. When the outside handle 1 is pushed, the door outer plate 2 is forcibly closed to thereby lock the door-locking mechanism.

As mentioned above, according to the present embodiment, the door-locking mechanism is unlocked by the operation of pulling the outside handle 1 and the door-locking mechanism is locked by the operation of pushing the outside handle 1. Therefore, it is not necessary to provide an exclusive switch in the vehicle door after locking or unlocking the door-locking mechanism, and it is possible to unlock the door-locking mechanism by the operation of opening the outside handle and to lock the door-locking mechanism by the operation of closing the outside handle. As a result, it is possible to unlock or lock the door-locking mechanism in accordance with the intention of the operator who operates the outside handle. That is, it is possible to unlock the door-locking mechanism by pulling the outside handle (the vehicle door is commonly opened by the operation of pulling the outside handle) and to lock the door-locking mechanism by pushing the outside handle (the vehicle door is commonly closed by the operation of pushing the vehicle door or the outside handle). As a result, it is possible to lock and unlock the door-locking mechanism in accordance with the operations of the outside handle intended by the operator (the intention of closing the vehicle door or opening the vehicle door). Incidentally, according to Patent Document 1 described in the related art, a method of operating the outside handle when the operator gets on a vehicle is not distinguished from a method of operating the outside handle when the operator gets off the vehicle. Therefore, the operation of the outside handle when the operator gets on a vehicle is not different from the operation of the outside handle when the operator gets off the vehicle.

According to the present invention, since the trigger signal for locking and unlocking the door-locking mechanism is generated by the operation of the outside handle for opening and closing the vehicle door without providing the exclusive switch, it is possible to realize the PKE system with a simple structure.

Further, since it is possible to unlock and lock the door-locking mechanism by the operation of pulling the outside handle and the operation of pushing the outside handle, it is possible to certainly and intentionally (without uncomfortable feeling) unlock and lock the door-locking mechanism.

What is claimed is:

1. A passive keyless entry system for locking or unlocking a vehicle door, the passive keyless entry system comprising trigger switches for transmitting a request signal to a portable unit,
wherein the trigger switches are attached to an outside handle for opening or closing the vehicle door,
wherein the trigger switches comprise a first switch turned on or off by the operation of pulling the outside handle from a normal position and a second switch turned on or off by the operation of pushing the outside handle from the normal position,
wherein a request signal is transmitted from the vehicle to the portable unit by the first switch operation and, when the request signal includes an authentic portable unit ID, the portable unit transfers a response signal to thereby unlock the vehicle door, and
wherein a request signal is transmitted from the vehicle to the portable unit by the second switch operation and, when the request signal includes an authentic portable unit ID, the portable unit transfers a response signal to thereby lock the vehicle door.

2. The passive keyless entry system according to claim 1,
wherein a driving unit is provided in the outside handle, and
wherein the first switch and the second switch are disposed on both sides of the driving unit.

3. The passive keyless entry system according to claim 1,
wherein the vehicle door is unlocked and then opened by the operation of pulling the outside handle from a normal position, and
wherein the vehicle door is closed and then locked by the operation of pushing the outside handle from a normal position.
